(19) United States
(12) Patent Application Publication
(10) Pub. No.: US 2024/0027698 A1
(43) Pub. Date: Jan. 25, 2024

(54) PHOTONICS INTEGRATED CIRCUIT DEVICE INCLUDING METALENS STRUCTURE AND SYSTEM INCLUDING SAME

(71) Applicants: Nicholas D. Psaila, Lanark (GB); Pooya Tadayon, Portland, OR (US)

(72) Inventors: Nicholas D. Psaila, Lanark (GB); Pooya Tadayon, Portland, OR (US)

(21) Appl. No.: 17/870,719

(22) Filed: Jul. 21, 2022

(51) Int. Cl. G02B 6/42

(52) U.S. Cl. CPC G02B 6/4206; G02B 6/4214; G02B 6/4244

(57) ABSTRACT

A photonic device, an integrated circuit device assembly including the photonic device, and a method of fabricating the photonic device. The device includes: a substrate; photonic circuitry on the substrate; an optical waveguide structure on the substrate; an optical coupler coupled to the photonic circuitry at one end thereof by way of the optical waveguide structure, and having a terminus at another end thereof to output an optical beam; and a metalens structure on the substrate, the metalens structure including a plurality of vertical nanostructures to configure an optical path between the optical coupler and an optical interface component that is to be optically coupled to the photonic device.

### BACKGROUND

Off-package input/output (I/O) bandwidth has been steadily increasing, and integrated circuit packaging and I/O technologies need to scale to meet this bandwidth demand. As a result, package pin counts and I/O data rates have also continued to increase. However, the reach of electrical I/O circuits (i.e., the length of electrical printed circuit board (PCB) traces or cables) has diminished with increasing data rates. Additionally, I/O energy efficiency improvement has drastically slowed, which has resulted in a quickly approaching I/O power wall for high-performance packages.

Photonic integrated circuits (PICs) have shown potential benefits for both power efficiency and bandwidth improvement. Photonic applications aim to achieve an expanded light beam (optical beam or beam) in an optical path that is to exist between an optical coupler (e.g., edge coupler or vertical coupler) and a component that is to communicate with the PIC optically (optical interface component). Where the transmission direction of the beam on the optical path is from the optical coupler to the optical interface component, the state of the art aims to expand the beam prior to the beam impinging on the optical interface component. Beam expansion gains alignment and tolerance margin with respect to an optical coupling of a PIC to the optical interface component. To do so, the state of the art uses hemispherical lenses and/or integrated mirrors on the PIC. These solutions include curved micro-optic surfaces on the PIC or on a separate substrate that is bonded to the PIC.

### BRIEF DESCRIPTION OF THE DRAWINGS

FIG. 1 illustrates an example PIC including a metalens according to a first embodiment.

FIG. 2 illustrates an example PIC assembly comprising a PIC that includes a metalens, and an optically transparent body on the PIC according to a second embodiment;

FIG. 3 illustrates an example PIC assembly comprising a PIC and a metalens structure on the PIC according to a third embodiment;

FIG. 4 illustrates an integrated circuit device assembly according to an embodiment.

FIG. 5 is a top view of a wafer and dies that may be included in a microelectronic assembly, in accordance with any of the embodiments disclosed herein.

FIG. 6 is a cross-sectional side view of an integrated circuit device that may be included in a microelectronic assembly, in accordance with any of the embodiments disclosed herein.

FIG. 7 is a cross-sectional side view of an integrated circuit device assembly that may include embodiments disclosed herein.

FIG. 8 is a block diagram of an example electrical device that may include a microelectronic assembly, in accordance with any of the embodiments disclosed herein.

FIG. 9 is a flow chart showing a process according to an embodiment.

### DETAILED DESCRIPTION

Embodiments herein provide photonic-based integrated circuit architectures that include a metalens structure that is at least one of part of a PIC, or optically coupled thereto, in order to provide a beam expansion region in an optical path between an optical coupler of the PIC and the optical interface component to receive optical beams from the PIC.

Some embodiments provide a photonic device including: a substrate, which could include silicon for example; photonic circuitry on the substrate; and a metalens structure on the substrate, the metalens structure including a plurality of vertical structures to reconfigure an optical path between the photonic circuitry and an optical interface component to be optically coupled to the photonic device.

The metalens structure (or metalens) serves to achieve beam expansion in the optical path without the need for current solutions for expanding the beam, such as bulky lens structures, integrated mirrors, or current curved micro-optic surfaces.

Some embodiments provide configurations where a metalens structure can be used to create expanded beams from PICs, providing advantages over formfactor, manufacturability and substrate size. Some embodiments include using the metalens to create beams that are both expanded (as compared with beams in an optical path from an optical coupler) and collimated.

There exist several issues in the prior art with existing solutions to expand the beam on the optical path between the optical coupler and the optical interface component. Traditional hemispherical lenses are bulky and require complex processes to assemble. Integrated mirrors on the PIC require complex fab processing and materials to create the intricate structures. Curved micro-optic surfaces typically require complex manufacturing processes such as greyscale lithography which can pose yield issues. Some curved micro-optic surfaces can further require significant material thickness to create an appropriate wavefront curvature, this can result in large, thick optical surfaces which may be undesirable in many applications.

Advantageously, some embodiments result in improvements to optical coupling performance on PICs, such as PICs including silicon, by creating expanded beam interfaces on the PIC, allowing for relaxed alignment tolerances at the optical interface with the optical interface component, which allows for low cost, high throughput assembly and test. Some embodiments advantageously result in improved yields, lower assembly costs, and improved wafer level test and sort.

As used herein, an “optical interface component” includes any component that is to be accessing optical signals in the form of optical beams. “Accessing” may include accessing externally (i.e. from a location external to the component), such as accessing from a PIC. “Accessing” may further include accessing internally (i.e. generating from a component internal to the component). For example, optical fibers, optical fiber arrays, mirrors, collimators waveguides, optical connectors, focusing elements such as lenses, lens arrays, photonic devices such as PICs, PIC packages, electronic integrated circuit chips (EICs), processing unit chips, etc., may be deemed to constitute an “optical interface component” as used herein.

As used herein, a beam that is “collimated” refers to an optical beam defining a wavefront that is substantially flat over a given distance. In the context of some embodiments, the given distance may correspond to an optical path between a metalens structure and a next optical interface component. A substantially flat wavefront of a beam refers to a wavefront of a beam where corresponding optical rays are substantially parallel to one another over the given distance.

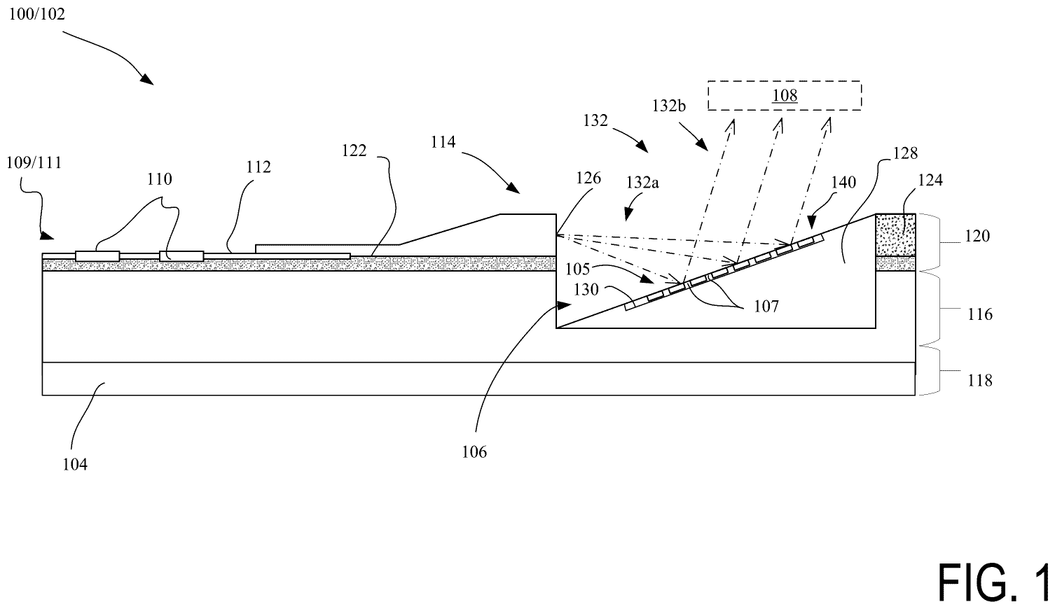

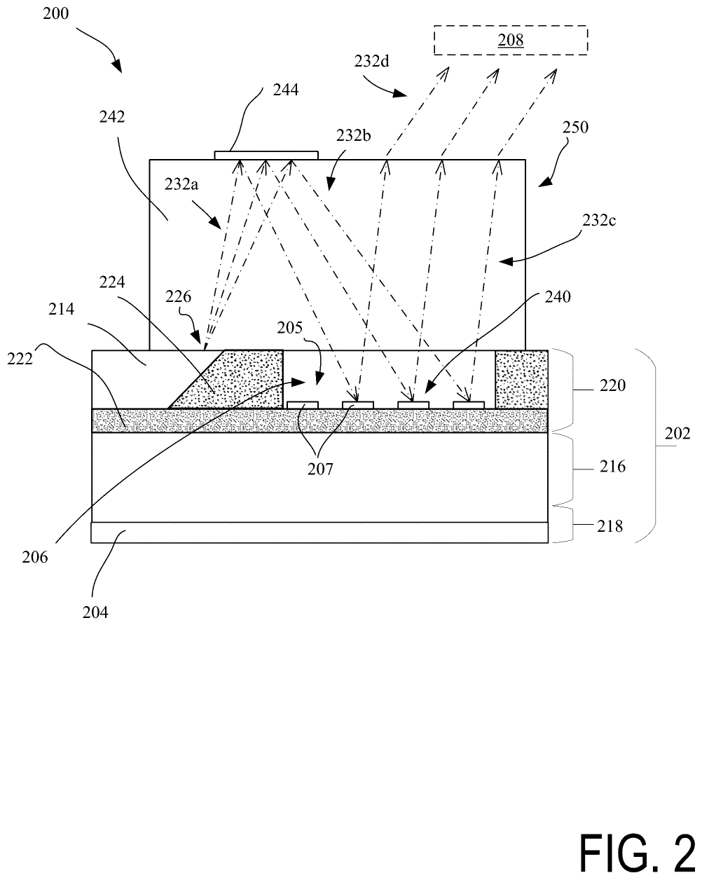

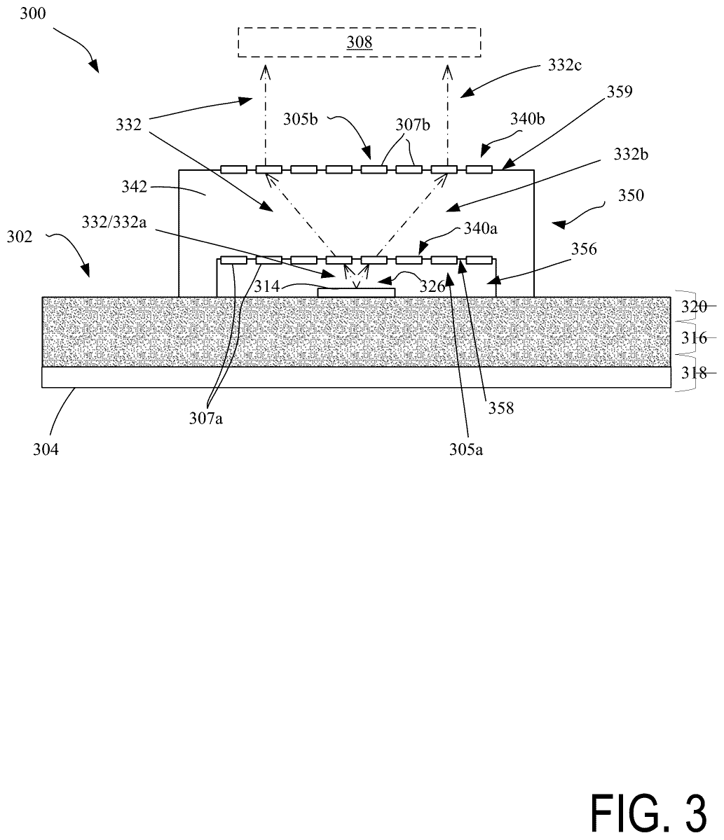

Let us now refer to FIGS. 1-3, which show examples of a photonic device according to three respective embodiments. In particular, FIGS. 1-3 illustrate examples of PICs 102, 202 and 302 according to a first, second and third embodiment, respectively, which PICs either include a metalens structure (FIGS. 1 and 2) or are assembled with a metalens structure (FIG. 3). Thus, the photonic device 100 and 200 include the PIC with a metalens structure that is part of the same, and photonic device 300 includes the PIC and a metalens assembly that is attached to the PIC.

The PIC in each example may include photonic circuitry therein, and may, in addition, include electrical circuitry therein. The PIC in each example may include optical to electrical conversion circuitry to receive optical signals from a source (e.g., the fibers 108, 208, 308), convert the optical signals to electrical signals, and provide the electrical signals to electrical circuitries within the PIC, or to electrical circuitries external to the PIC (e.g., to an electronic integrated circuit (EIC) and/or a processing unit (XPU)). Likewise, the PIC may include electrical to optical conversion circuitry to receive electrical signals from electrical circuitries within the PIC, or from electrical circuitries external to the PIC, generate optical signals based on the electrical signals, and provide the optical signals to the fibers.

Optical interface components 108, 208 and 308 are shown in FIGS. 1-3 in schematic form and in broken lines, and represent a myriad of possible optical interface components that may be used to optically couple to the PIC in individual embodiments, some examples of which are provided above.

The photonic circuitry 109, 209, 309 of the PIC may include optical components, for example, one or more lasers or other light sources, detectors, amplitude and/or phase modulators, filters, splitters, amplifiers, interferometers, micro-ring resonators, gratings, squeezed or other quantum light sources, etc. The photonic circuitry may perform other functions beyond converting optical signals to electrical signals or vice versa, e.g., matrix multiplication, quantum logic gates, optical compute gates, etc. Although not shown, the PIC may be coupled to an EIC that may include circuitry to control and/or drive the circuitry within the PIC and/or other electrical circuitry for processing the signals from the PIC. For instance, the EIC may include components such as, for example, transimpedance amplifiers (TIA), serializer/deserializer (SERDES) circuits, driver circuits, etc. The optical signals may be received from an array of fiber, e.g., a fiber pigtail connection, that is coupled to the PIC, e.g., via v-groove connections.

The photonic circuitry may, according to an example, include IMOS (InP membrane on silicon) devices including indium and phosphide nanophotonic circuitry within one or more photonic layers of the PIC. The one or more photonic layers may be supported on a substrate of the PIC, such as a silicon substrate.

The optical couplers 114, 214 and 314 of FIGS. 1-3, respectively, may communicate optical beams with the waveguide structure 112/212/312, and may, when outputting an optical beam from their terminus, expand the optical beam (i.e. increase its divergence angle/extend its diameter/width) with respect to an optical beam within the waveguide structure. Such beam expansion is shown for example in FIGS. 1, 2 and 3 respectively by optical path portions 132a, 232a, and 332a. In some examples, a diameter of the beam (or width of the beam) emerging from an optical coupler may be between about 5 microns to about 10 microns. An optical coupler of some embodiments may include one or more material layers. The material layers of individual ones of the optical couplers may include at least one of silicon, oxygen or nitrogen. At least one of those material layers may be tapered, for example tapered in a general direction of optical propagation to or from the optical coupler.

The metalens structures 140, 240 of FIGS. 1 and 2 respectively, may each include a reflective metalens structure, although embodiments are not so limited. The metalens structures 140/240/340a/340b may have a plurality of vertical structures 107/207/307a/307b patterned thereon. The vertical structures may include sidewalls that extend vertically relative to a exposed surface 105/205/305a/305b of the metalens structure 140/240/340a/340b as shown. The vertical structures may include nanostructures. The vertical structures may include, for example, pillars (vertical structures having identical heights with respect to one another and distinct from one another). Individual ones of the pillars may have any cross section, such as, for example, a circular, rectangular, square, triangular, diamond or other cross sections. A same metalens may have vertical structures of different cross-sectional shapes, cross-sectional dimensions, and/or different pitches with respect to one another (different densities) According to an embodiment, the vertical structures may define a heterogenous pattern across an exposed surface of the metalens. For example, the vertical structures may define a pattern that changes in a direction from a central region of the exposed surface toward a periphery of the exposed surface. For example, the vertical structures may be more or less densely spaced with respect to one another at a central region of the exposed surface and be progressively less or more (respectively) densely spaced with respect to one another in a direction from the central region of the exposed surface of the metalens toward a periphery of the exposed surface of the metalens. The pattern defined by the vertical structures of the metalens structure may be configured to tune the exposed surface of the metalens structure to achieve a desired/predetermined manipulation or configuration of the optical path between the optical coupler and the optical interface component.

The metalens structure may include at least one of a metal material or a dielectric material. The vertical structures, such as vertical nanostructures, may be formed from a material of the metalens structure, for example by way of depositing the material of the metalens structure and thereafter etching it. The vertical structures of a metalens structure according to some embodiments may cause optical beams impinging on a surface of the metalens structure to expand, that is, to increase in diameter, and optionally also to be collimated.

Advantageously, a metalens structure used in a photonic device according to embodiments, by expanding and optionally collimating a beam from an optical coupler of a PIC, may facilitate integrating a PIC into a microelectronic assembly and/or into an integrated circuit package by relaxing an alignment accuracy required between the PIC and an optical interface component to receive optical signals from the PIC. In this manner, PIC assembly tolerances are reduced. In this manner, a metalens structure used in a photonic device according to some embodiments may do away with the need to integrate bulky and hard to manufacture beam expanders onto the PIC in order to allow optical signal communication.

The optical paths 132/232/332 between an optical coupler 114/214/314 and an optical interface component 108/208/308 of FIGS. 1, 2, and 3, respectively may correspond to optical beams to propagate in a direction from the optical coupler 114/214/314 toward the optical interface component 108/208/308 when the PIC is outputting optical signals. Optical paths would also exist that correspond to optical beams to propagate in an opposite direction, that is, a direction from the optical interface component 108/208/308 toward the edge coupler 114/214/314 when the PIC is receiving optical signals.

Reference is made to FIG. 1, which shows a portion of a photonic device 100 according to a first embodiment. The photonic device 100 includes a PIC 102. The PIC includes a substrate 104, which may for example include silicon. The substrate 104 defines a cavity 106 therein. The PIC 102 further includes a metalens structure 140 disposed in the cavity.

In this shown embodiment, the metalens structure 140 is disposed entirely within cavity 106, although embodiments are not so limited, and include within their scope a metalens structure which is disposed partially within the substrate cavity. The metalens structure 140 is shown as having been disposed on a filler material 128. The filler material 128 may define a slanted or ramped surface 130 within cavity 106, the metalens structure 140 on the ramped surface 130. Filler material 128 may include silicon and oxygen, or a polymer material, and may be deposited in the cavity 106 after formation of the cavity, and etched to form the ramped surface 130. The ramped surface 130 may define a predetermined angle with respect to a top surface of the PIC 102. On top of the slanted surface, metalens structure 140, which, in the shown embodiment of FIG. 1, is a reflective metalens structure, may be patterned to provide the vertical structures 107 on the exposed surface 105 of the metalens structure.

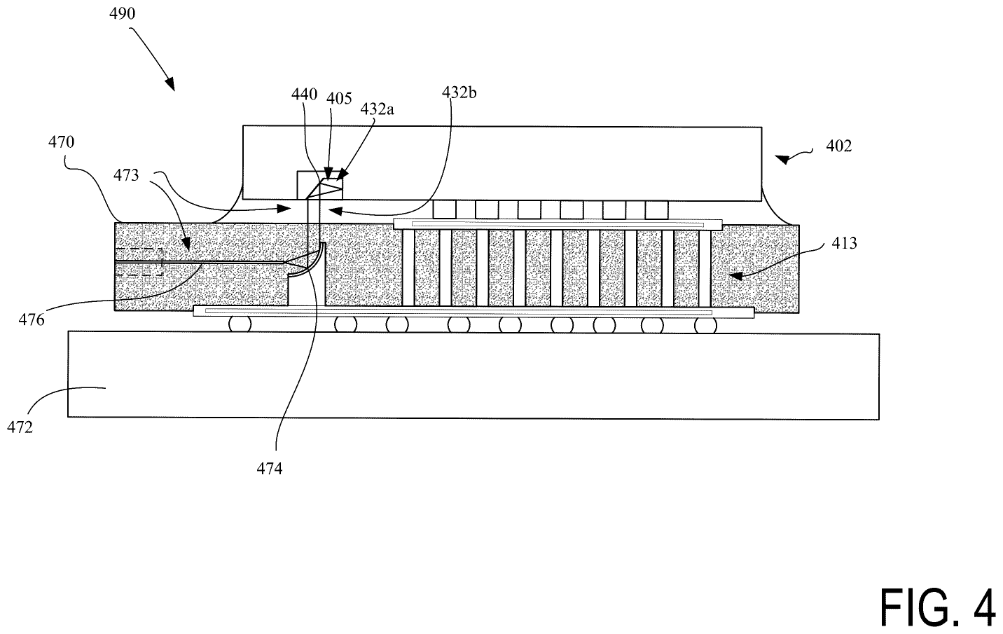

Photonic circuitry 109 may be disposed on the substrate, such as in a photonic layer 111, and may include optical components 110 optically coupled with an optical waveguide structure 112 on the substrate. The optical waveguide structure 112 may include one or more waveguide layers of silicon, oxygen or nitrogen. The photonic layer 111 may be disposed on the substrate at a back end region of PIC 102, as will be discussed in more detail in the discussion of the integrated circuit package 400 of FIG. 4 below.

PIC 102 may include a back-end-of-line BEOL region 116 between a front-end-of-line FEOL region 118 and a photonic region 120. The photonic region 120 may include the photonic circuitry 109 and the one or more photonic layers 111, and a dielectric layer 122 adjacent a bottom surface of the one or more photonic layer 111. The dielectric layers 122 may, for example, include oxygen, such as an oxide material. The photonic region 120 may further include other dielectric materials, such as a dielectric layer 124 on a top surface of the dielectric layer 122. Dielectric layer 144 may for example include nitrogen, such as a nitride material.

Photonic device 100 may further include an optical coupler, which, in the embodiment of FIG. 1, comprises an edge coupler 114 that is coupled to the optical components 110 by way of the optical waveguide structure 112. Edge coupler 114 includes a terminus 126 which corresponds to an input/output thereof. The terminus 126 abuts cavity 106.

For the photonic device 100 of FIG. 1, the shown embodiment depicts an optical path 132 between the edge coupler 114 and the optical interface component 108. As noted previously, the optical path 132 may correspond to optical beams to propagate in a direction from the edge coupler 114 toward the optical interface component 108 or in the opposite direction when the PIC is receiving optical signals. Optical path 132 in the shown embodiment includes a first optical path portion 132a between the edge coupler 114 and the metalens structure 140, and a second optical path portion 132b between the metalens 140 and the optical interface component 108. The exposed surface 105 is at an angle with respect to the terminus 126 of edge coupler 114 in such a way that, when the expanded optical beam from first optical path portion 132a impinges upon the metalens structure 140, the metalens structure 140 configures the optical path 132 by reflecting the expanded optical beam, and, in the shown embodiment, by also collimating the expanded optical beam, thus defining second optical path portion 132b. The expanded collimated optical beam in second optical path portion 132b may then be accessed by the optical interface component 108 as shown.

According to an embodiment, a width of the cavity 106 may be about a few hundred microns, such as for example 200 microns, and its height may be between about 50 and about 60 microns. According to an embodiment, the metalens structure 140 may configure the optical path 132 such that a beam with a diameter between about 5 microns and about 10 microns emerging from the edge coupler 114 may, after being configured by the metalens structure 140, change into an expanded optical beam having a diameter between about 40 microns and about 50 microns. Such expansion, and optional collimation by the metalens structure 140 can lead to an almost 10× reduction in misalignment sensitivity between the PIC and the optical interface device.

Reference is made to FIG. 2, which shows a portion of a photonic device 200 according to a second embodiment. The photonic device 200 includes a PIC 202, and a transparent block assembly 250 on the PIC. The PIC includes a substrate 204, which may for example include silicon. The substrate 204 defines a cavity 206 therein. The PIC 202 further includes a metalens structure 240 disposed in the cavity.

The metalens structure 240 is shown as having been disposed on a dielectric layer 222 such that its exposed surface 205 faces away from substrate 204 and is substantially parallel with a bottom surface of the cavity 206. Metalens structure 240, which, in the shown embodiment of FIG. 2, is a reflective metalens structure, may be patterned to provide the vertical structures 207 on the exposed surface 205 of the metalens structure.

A photonic circuitry (not shown in FIG. 2) similar to that of FIG. 1 may be disposed on the substrate, such as in a photonic layer, and may include optical components optically coupled with an optical waveguide structure on the substrate. The optical waveguide structure may include one or more waveguide layers of silicon, oxygen or nitrogen. The photonic layer may be disposed on the substrate at a back end region of PIC 202, as will be discussed in more detail in the discussion of the integrated circuit package 400 of FIG. 4 below.

PIC 202 may include a back-end-of-line BEOL region 216 between a front-end-of-line FEOL region 218 and a photonic region 220. The photonic region 220 may include the photonic circuitry and the one or more photonic layers, and dielectric layer 222 adjacent a bottom surface of the one or more photonic layer. The photonic region 220 may further include other dielectric materials, such as a dielectric layer 224 on a top surface of the dielectric layer 222. Dielectric layer 244 may for example include nitrogen, such as a nitride material.

PIC 202 may further include an optical coupler, which, in the embodiment of FIG. 2, comprises an vertical coupler 214 that is coupled to the optical components by way of the optical waveguide structure described above but not shown. The vertical coupler 214 may for example include a grating couplers or embedded mirrors. Vertical coupler 214 includes a terminus 226 which corresponds to an input/output thereof. The terminus is to serve as a light input or output for optical beams such that the beam propagates upward and, for example, at an angle different from 90 degrees relative to a top surface of the PIC.

The photonic device 200 further includes a transparent block assembly 250 which includes an optically transparent block 242 abutting a top surface of PIC 202 and covering cavity 206. The transparent block 242 may include a transparent material, such as, for example, glass or silicon. The transparent block assembly 250 further includes a mirror 244, such as a metal layer disposed on a top surface of the transparent block 242. The mirror 244 may be planar as shown, or nonplanar.

For the photonic device 200 of FIG. 2, the shown embodiment depicts an optical path 232 between the vertical coupler 214 and the optical interface component 208. As noted previously, the optical path 232 may correspond to optical beams to propagate in a direction from the vertical coupler 214 toward the optical interface component 208 or in the opposite direction when the PIC is receiving optical signals. Optical path 232 in the shown embodiment includes a first optical path portion 232a through the transparent block 242 between the vertical coupler 214 and the mirror 244, a second optical path 232b through the transparent block between the mirror 244 and metalens structure 240, and a third optical path portion 232c through the transparent block 242 between the metalens 240 and a top surface of the transparent block 242. A fourth optical path portion 232d then corresponds to an optical beam between the top surface of the transparent block 242 and the optical interface component 208. The terminus 226 of vertical coupler 214, the transparent block 242, the mirror 244 and the metalens structure 240 are disposed with respect to one another in such a way that, when the expanded optical beam from first optical path portion 232a impinges upon the mirror 244, is reflected in the second optical path portion 232b by the mirror 244 toward the metalens structure 240, the metalens structure 240 configuring the optical path 232 by reflecting the expanded optical beam from mirror 244, and, in the shown embodiment, by also collimating the expanded optical beam, thus defining third optical path portion 232c. The expanded collimated optical beam in third optical path portion 232c may then be accessed by the optical interface component 208 as shown.

According to an embodiment, a width of the cavity 206 may be about a hundred microns, and its height may be between about 5 and about 10 microns, thus much smaller than a cavity 106 of the first embodiment as shown by way of example in FIG. 1. In addition, according to an embodiment, the mirror 244 may have a length of about 20 microns.

According to an embodiment, the metalens structure 240 may configure the optical path 232 such that a beam with a diameter between about 5 microns and about 10 microns emerging from the vertical coupler 214 may, after going through two stages of expansion (once by way of mirror 244, and once again by way of metalens structure 240), change into an expanded optical beam having a diameter between about 40 microns and about 50 microns. Such expansion, and optional collimation by the metalens structure 240 can lead to an almost reduction in misalignment sensitivity between the PIC and the optical interface device.

Advantageously, the embodiment of FIG. 2 is relatively simple to fabricate, as it requires no lithography of a filler material within cavity 206, and, although it requires the assembly of transparent block and of the mirror thereon, such assembly does not require a high level of alignment accuracy.

Reference is made to FIG. 3, which shows a portion of a photonic device 300 according to a third embodiment. The photonic device 300 includes a PIC 302, and a metalens assembly 350 disposed on the PIC. The PIC includes a substrate 304, which may for example include silicon. The metalens assembly 350 includes a micro-optic block 342, and two metalens structures 340a and 340b on the micro-optic block 342. In the embodiment of FIG. 3, as opposed to the embodiments of FIGS. 1 and 2, metalens structures are not shown as being part of the PIC, but are provided proximate the PIC in order to optically communicate therewith.

Transparent block 350 may include a material such as glass or silicon, or any other optically transparent material or materials, and, as depicted in the shown embodiment, may optionally define a cavity 356 which may be etched into a transparent block material. Optional cavity 356 is to allow for a predetermined standoff distance between the PIC vertical coupler 314 and the negative first metalens structure 340a. This can allow for an initial amount of divergence from PIC 302 to the first metalens structure 340a in order to increase the diameter and relax the manufacturing tolerances required for the negative metalens assembly 340a.

The transparent block 350 includes a PIC facing surface 358, which surface 358 partially defines cavity 356, and a outward facing surface 359, which faces away from the PIC 302. A first metalens structure 340a is disposed on the PIC facing surface 358 and faces a vertical coupler 314 of PIC 312. A second metalens structure 340b is disposed on the outward facing surface 359 and faces in a direction toward an optical interface component to be coupled to the PIC 302. Both metalens structures 340a and 340b are substantially parallel with surfaces 358 and 359 respectively. Metalens structures 340a and 340b, which, in the shown embodiment of FIG. 3, are, respectively, a negative refractive metalens structure and a positive refractive metalens structure. First metalens structure 340a, as a negative metalens structure, is to increase the divergence angle of the beam exiting the PIC and, in this way, reduces the required thickness of the micro-optic block. Otherwise, the micro optic block would have had to be taller in order to allow a diffracted optical light beam from the vertical coupler 314 to reach the width necessary.

Individual metalens structures 340a and 340b, may be patterned to provide the vertical structures 307a and 307b respectively on the exposed surfaces 305a and 305b of the metalens structure.

The PIC may include photonic circuitry (not shown in FIG. 3) similar to that of FIG. 1 may be disposed on the substrate, such as in a photonic layer, and may include optical components optically coupled with an optical waveguide structure on the substrate. The optical waveguide structure may include one or more waveguide layers of silicon, oxygen or nitrogen. The photonic layer may be disposed on the substrate at a back end region of PIC 302, as will be discussed in more detail in the discussion of the integrated circuit package 400 of FIG. 4 below.

PIC 302 may include a back-end-of-line BEOL region 316 between a front-end-of-line FEOL region 318 and a photonic region 320. The photonic region 320 may include the photonic circuitry and the one or more photonic layers. The photonic region 320 may include dielectric materials including at least one of silicon, oxygen or nitrogen.

PIC 302 may further include an optical coupler, which, in the embodiment of FIG. 3, comprises an vertical coupler 314 that is coupled to the optical components by way of the optical waveguide structure described above but not shown. The vertical coupler 314 may for example include a grating couplers or embedded mirrors. Vertical coupler 314 includes a terminus 326 which corresponds to an input/output thereof. The terminus is to serve as a light input or output for optical beams such that the beam propagates upward relative to a top surface of the PIC 302.

The photonic device 300 further includes a micro-optic block 342 abutting a top surface of PIC 302 and covering cavity 306. The micro-optic block 342 may include a transparent material, such as, for example, glass or silicon.

For the photonic device 300 of FIG. 3, the shown embodiment depicts an optical path 332 between the vertical coupler 314 and the optical interface component 308. As noted previously, the optical path 332 may correspond to optical beams to propagate in a direction from the vertical coupler 314 toward the optical interface component 308 or in the opposite direction when the PIC is receiving optical signals. Optical path 332 in the shown embodiment includes a first optical path portion 332a in cavity 356 between vertical coupler 314 and the first metalens structure 340a, this first optical path portion 332a exhibiting an expansion of an optical beam in a direction from the vertical coupler 314 toward the first metalens structure 340a. Optical path 332 further includes a second optical path portion 332b through the micro-optic block 342 between the first metalens structure 340a and the second metalens structure 340b. This second optical path portion 332b exhibits an expansion of the optical beam as compared with the optical path portion 332a, the expansion effected by way of refraction by configuration of the optical beam by first metalens structure 340a when light travels from the PIC toward the optical interface component 308. A third optical path portion 332c is defined between the second metalens structure 340b and an optical interface component 308 to be optically coupled to the PIC. The terminus 326 of vertical coupler 314, the micro-optic block 342, and the metalens structures 340a and 340b are disposed with respect to one another in such a way that, when the expanded optical beam from first optical path portion 332a impinges upon the first metalens structure 340a, it is expanded by way of refraction within transparent block 342 to yield second optical path portion 332b, the first metalens structure 340a configuring the optical path 332 by refracting the expanded optical beam in the first optical path portion 332a. The expanded optical beam from second optical path portion 332b is then configured by second metalens structure 340b by being collimated, thus defining third optical path portion 332c. The expanded collimated optical beam in third optical path portion 332c may then be accessed by the optical interface component 308 as shown.

According to an embodiment, a width of the micro optic block 350 may be about a hundred microns to about 200 microns, and its height may be between about 50 and about 100 microns, thus in roughly a same order of magnitude as metalens assembly 350 of the second embodiment as shown by way of example in FIG. 2. According to an embodiment, the metalens structure 340 may configure the optical path 332 such that a beam with a diameter between about 5 microns and about 10 microns emerging from the vertical coupler 314 may, after going through two stages of expansion (once by way of first metalens structure 340a, and once again by way of second metalens structure 340b), change into an expanded optical beam having a diameter between about 40 microns and about 50 microns. Such expansion, and optional collimation by the metalens structures 340a and 340b can lead to an almost 10× reduction in misalignment sensitivity between the PIC and the optical interface device.

Advantageously, the embodiment of FIG. 3 is relatively simple to fabricate, as it requires no lithography of a filler material within cavity 306, and, although it requires the assembly of metalens assemblies thereon, such assembly does not require a high level of alignment accuracy.

The metalens structures in these configurations can be used to diffractively beam shape as well as collimate, either through reflection or refraction, creating configuration such as Bessel beams or other well-known beam shapes to enable an optical coupler of a PIC to be used in a large number of applications, such as 3D sensing (e.g., using dot arrays), or aberration pre-compensation for focusing deep into materials, or through optical interface components with large refractive index contrasts.

In some embodiments, each example PIC may have a single dedicated optical interface component; however, in other embodiments, an optical interface component may communicate optical signals with multiple example PICs, or an example PIC may transmit optical signals to multiple optical interface components.

Optical interface components according to embodiments may optically couple to the PICs from any angle not limited to the angle of the optical path portion exiting the photonic devices 100, 200 or 300. Still further, although shown as one piece of glass or silicon in FIGS. 2 and 3, the transparent block 242 or 342 does not need to correspond of a unitary piece, and may potentially include be multiple pieces and/or may include other elements. For example, in some embodiments, the transparent may include thermal vias (e.g., Cu plugs) or micro fluidics for cooling purposes.

Reference is now made to FIG. 4, which shows an integrated circuit (IC) device assembly 490 including a photonic device 400 according to an embodiment. In IC device assembly 490, a glass interposer 470 is disposed between a PIC 402 and a printed circuit board (PCB) 472. PIC 402 in the shown embodiment corresponds to PIC 102 of FIG. 1 by way of example, except that collimated optical signals from PIC 402 emerge from the PIC 402 vertically rather than at an angle. Glass interposer 470 may for example correspond to the optical interface component 108 of the first embodiment as shown schematically in FIG. 1. Glass interposer 470 may include optical pathways 473 with one or more optical elements, e.g., laser written waveguide(s) 476, curved micromirrors such as curved micromirror 474, collimators, focusing elements, etc. that direct optical beams between the PIC 102 and the glass interposer 470. In addition, the glass interposer 470 may be thick enough to enable a detachable fiber array to connect to the package 490, e.g., may be hundreds of microns thick, or thicker. The glass interposer 470 also includes a number of through glass vias (TGVs) 413 that electrically connect the PIC 402 and the PCB 472.

As seen in FIG. 4, PIC 402 defines a cavity 406 therein, and includes a filler material 428 defining a ramped surface inside cavity 406. A metalens structure 440 similar to metalens structure 140 of FIG. 1 is provided on the ramped surface of filler material 428. An optical path 432b is shown between PIC 402 and glass interposer 470, and an optical path 432a between an edge coupler 414 and the metalens assembly of the PIC 402. An optical beam emerging from the metalens structure 440 is shown as impinging on a curved micromirror 474, and is then focused onto waveguide 476 of glass interposer 470 and guided toward other optical interface components of IC device assembly 490.

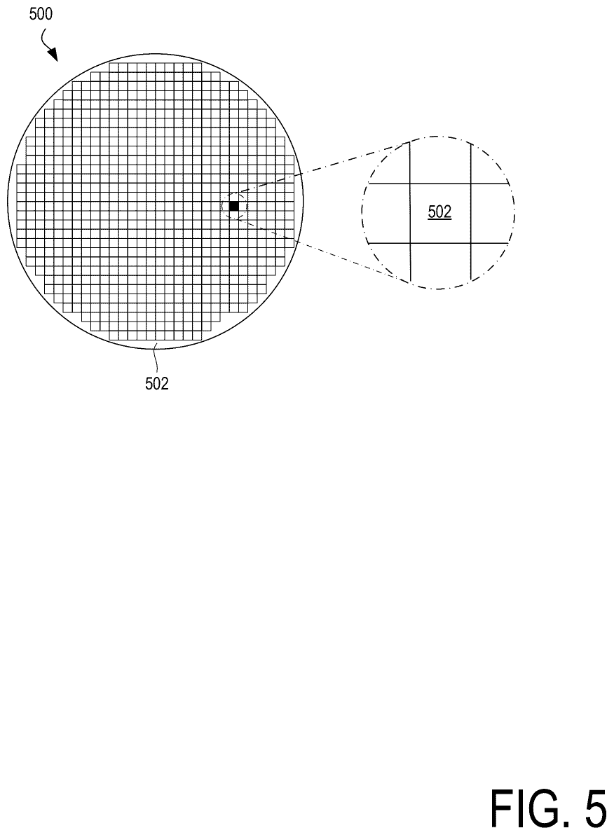

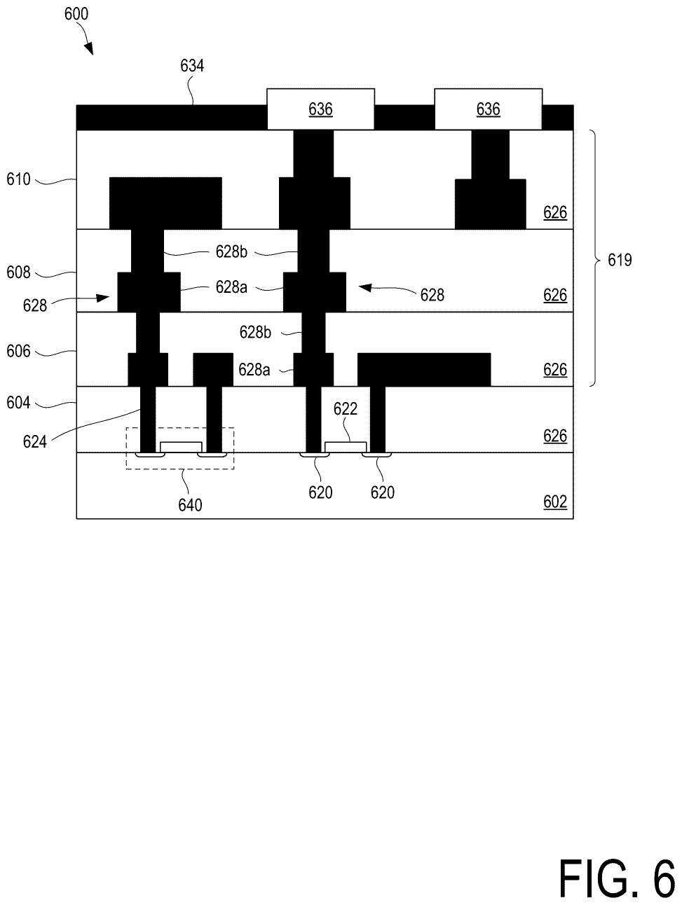

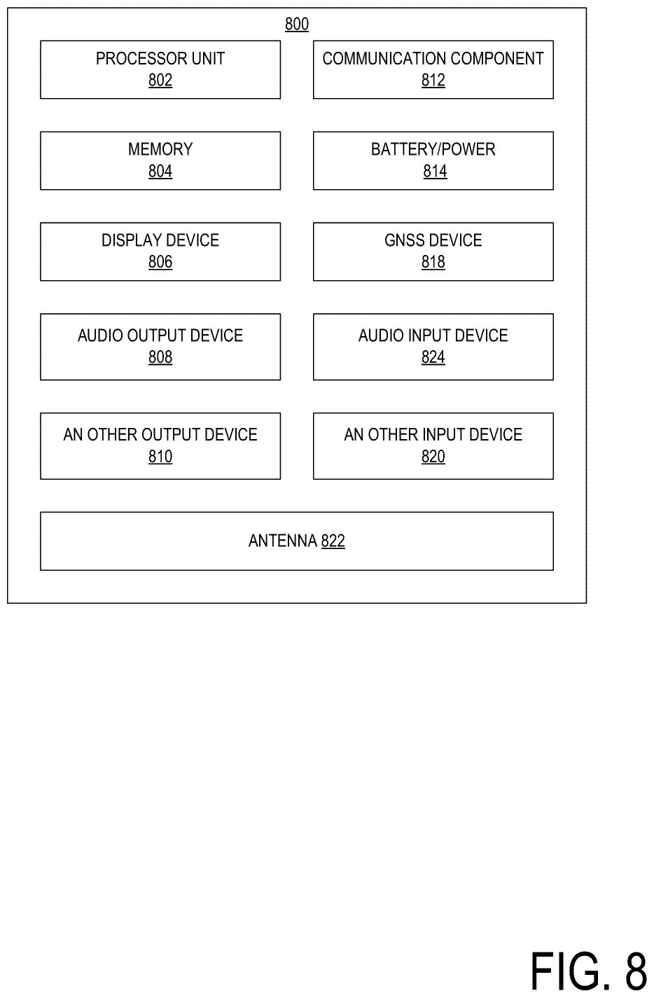

FIG. 5 is a top view of a wafer 500 and dies 502 that may be implemented in or along with any of the embodiments disclosed herein. The wafer 500 may be composed of semiconductor material and may include one or more dies 502 having integrated circuit structures, such as any of the embodiments of a PIC described above, formed on a surface of the wafer 500. The individual dies 502 may be a repeating unit of an integrated circuit product that includes any suitable integrated circuit. After the fabrication of the semiconductor product is complete, the wafer 500 may undergo a singulation process in which the dies 502 are separated from one another to provide discrete “chips” of the integrated circuit product. The die 502 may include one or more transistors (e.g., some of the transistors 640 of FIG. 6, discussed below), supporting circuitry to route electrical signals to the transistors, passive components (e.g., signal traces, resistors, capacitors, or inductors), and/or any other integrated circuit components. In some embodiments, the wafer 500 or the die 502 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 502. For example, a memory array formed by multiple memory devices may be formed on a same die 502 as a processor unit (e.g., the processor unit 802 of FIG. 8) or other logic that is configured to store information in the memory devices or execute instructions stored in the memory array.

FIG. 6 is a cross-sectional side view of an integrated circuit device 600, such as a photonic device according to any of the embodiments disclosed herein. One or more of the integrated circuit devices 600 may be included in one or more dies 502 (FIG. 5). The integrated circuit device 600 may be formed on a die substrate 602 (e.g., the wafer 500 of FIG. 5) and may be included in a die (e.g., the die 502 of FIG. 5). The die substrate 602 may be a semiconductor substrate composed of semiconductor material systems including, for example, n-type or p-type materials systems (or a combination of both). The die substrate 602 may include, for example, a crystalline substrate formed using a bulk silicon or a silicon-on-insulator (SOI) substructure. In some embodiments, the die substrate 602 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 602. Although a few examples of materials from which the die substrate 602 may be formed are described here, any material that may serve as a foundation for an integrated circuit device 600 may be used. The die substrate 602 may be part of a singulated die (e.g., the dies 502 of FIG. 5) or a wafer (e.g., the wafer 500 of FIG. 5).

The integrated circuit device 600 may include one or more device layers 604 disposed on the die substrate 602. The device layer 604 may include features of one or more transistors 640 (e.g., metal oxide semiconductor field-effect transistors (MOSFETs)) formed on the die substrate 602. The transistors 640 may include, for example, one or more source and/or drain (S/D) regions 620, a gate 622 to control current flow between the S/D regions 620, and one or more S/D contacts 624 to route electrical signals to/from the S/D regions 620. The transistors 640 may include additional features not depicted for the sake of clarity, such as device isolation regions, gate contacts, and the like. The transistors 640 are not limited to the type and configuration depicted in FIG. 6 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

Returning to FIG. 6, a transistor 640 may include a gate 622 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 640 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 640 along the source-channel-drain direction, the gate electrode may consist of a U-shaped structure that includes a bottom portion substantially parallel to the surface of the die substrate 602 and two sidewall portions that are substantially perpendicular to the top surface of the die substrate 602. In other embodiments, at least one of the metal layers that form the gate electrode may simply be a planar layer that is substantially parallel to the top surface of the die substrate 602 and does not include sidewall portions substantially perpendicular to the top surface of the die substrate 602. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 620 may be formed within the die substrate 602 adjacent to the gate 622 of individual transistors 640. The S/D regions 620 may be formed using an implantation/diffusion process or an etching/deposition process, for example. In the former process, dopants such as boron, aluminum, antimony, phosphorous, or arsenic may be ion-implanted into the die substrate 602 to form the S/D regions 620. An annealing process that activates the dopants and causes them to diffuse farther into the die substrate 602 may follow the ion-implantation process. In the latter process, the die substrate 602 may first be etched to form recesses at the locations of the S/D regions 620. An epitaxial deposition process may then be carried out to fill the recesses with material that is used to fabricate the S/D regions 620. In some implementations, the S/D regions 620 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 620 may be formed using one or more alternate semiconductor materials such as germanium or a group III-V material or alloy. In further embodiments, one or more layers of metal and/or metal alloys may be used to form the S/D regions 620.

Electrical signals, such as power and/or input/output (I/O) signals, may be routed to and/or from the devices (e.g., transistors 640) of the device layer 604 through one or more interconnect layers disposed on the device layer 604 (illustrated in FIG. 6 as interconnect layers 606-610). For example, electrically conductive features of the device layer 604 (e.g., the gate 622 and the S/D contacts 624) may be electrically coupled with the interconnect structures 628 of the interconnect layers 606-610. The one or more interconnect layers 606-610 may form a metallization stack (also referred to as an “ILD stack”) 619 of the integrated circuit device 600.

The interconnect structures 628 may be arranged within the interconnect layers 606-610 to route electrical signals according to a wide variety of designs; in particular, the arrangement is not limited to the particular configuration of interconnect structures 628 depicted in FIG. 6. Although a particular number of interconnect layers 606-610 is depicted in FIG. 6, embodiments of the present disclosure include integrated circuit devices having more or fewer interconnect layers than depicted.

In some embodiments, the interconnect structures 628 may include lines 628a and/or vias 628b filled with an electrically conductive material such as a metal. The lines 628a may be arranged to route electrical signals in a direction of a plane that is substantially parallel with a surface of the die substrate 602 upon which the device layer 604 is formed. For example, the lines 628a may route electrical signals in a direction in and out of the page and/or in a direction across the page from the perspective of FIG. 6. The vias 628b may be arranged to route electrical signals in a direction of a plane that is substantially perpendicular to the surface of the die substrate 602 upon which the device layer 604 is formed. In some embodiments, the vias 628b may electrically couple lines 628a of different interconnect layers 606-610 together.

The interconnect layers 606-610 may include a dielectric material 626 disposed between the interconnect structures 628, as shown in FIG. 6. In some embodiments, dielectric material 626 disposed between the interconnect structures 628 in different ones of the interconnect layers 606-610 may have different compositions; in other embodiments, the composition of the dielectric material 626 between different interconnect layers 606-610 may be the same. The device layer 604 may include a dielectric material 626 disposed between the transistors 640 and a bottom layer of the metallization stack as well. The dielectric material 626 included in the device layer 604 may have a different composition than the dielectric material 626 included in the interconnect layers 606-610; in other embodiments, the composition of the dielectric material 626 in the device layer 604 may be the same as a dielectric material 626 included in any one of the interconnect layers 606-610.

A first interconnect layer 606 (referred to as Metal 1 or “M1”) may be formed directly on the device layer 604. In some embodiments, the first interconnect layer 606 may include lines 628a and/or vias 628b, as shown. The lines 628a of the first interconnect layer 606 may be coupled with contacts (e.g., the S/D contacts 624) of the device layer 604. The vias 628b of the first interconnect layer 606 may be coupled with the lines 628a of a second interconnect layer 608.

The second interconnect layer 608 (referred to as Metal 2 or “M2”) may be formed directly on the first interconnect layer 606. In some embodiments, the second interconnect layer 608 may include via 628b to couple the lines 628 of the second interconnect layer 608 with the lines 628a of a third interconnect layer 610. Although the lines 628a and the vias 628b are structurally delineated with a line within individual interconnect layers for the sake of clarity, the lines 628a and the vias 628b may be structurally and/or materially contiguous (e.g., simultaneously filled during a dual-damascene process) in some embodiments.

The third interconnect layer 610 (referred to as Metal 3 or “M3”) (and additional interconnect layers, as desired) may be formed in succession on the second interconnect layer 608 according to similar techniques and configurations described in connection with the second interconnect layer 608 or the first interconnect layer 606. In some embodiments, the interconnect layers that are “higher up” in the metallization stack 619 in the integrated circuit device 600 (i.e., farther away from the device layer 604) may be thicker that the interconnect layers that are lower in the metallization stack 619, with lines 628a and vias 628b in the higher interconnect layers being thicker than those in the lower interconnect layers.

The integrated circuit device 600 may include a solder resist material 634 (e.g., polyimide or similar material) and one or more conductive contacts 636 formed on the interconnect layers 606-610. In FIG. 6, the conductive contacts 636 are illustrated as taking the form of bond pads. The conductive contacts 636 may be electrically coupled with the interconnect structures 628 and configured to route the electrical signals of the transistor(s) 640 to external devices. For example, solder bonds may be formed on the one or more conductive contacts 636 to mechanically and/or electrically couple an integrated circuit die including the integrated circuit device 600 with another component (e.g., a printed circuit board or a package substrate, e.g., 112). The integrated circuit device 600 may include additional or alternate structures to route the electrical signals from the interconnect layers 606-610; for example, the conductive contacts 636 may include other analogous features (e.g., posts) that route the electrical signals to external components.

In some embodiments in which the integrated circuit device 600 is a double-sided die, the integrated circuit device 600 may include another metallization stack (not shown) on the opposite side of the device layer(s) 604. This metallization stack may include multiple interconnect layers as discussed above with reference to the interconnect layers 606-610, to provide conductive pathways (e.g., including conductive lines and vias) between the device layer(s) 604 and additional conductive contacts (not shown) on the opposite side of the integrated circuit device 600 from the conductive contacts 636.

In other embodiments in which the integrated circuit device 600 is a double-sided die, the integrated circuit device 600 may include one or more through silicon vias (TSVs) through the die substrate 602; these TSVs may make contact with the device layer(s) 604, and may provide conductive pathways between the device layer(s) 604 and additional conductive contacts (not shown) on the opposite side of the integrated circuit device 600 from the conductive contacts 636. In some embodiments, TSVs extending through the substrate can be used for routing power and ground signals from conductive contacts on the opposite side of the integrated circuit device 600 from the conductive contacts 636 to the transistors 640 and any other components integrated into the die 600, and the metallization stack 619 can be used to route I/O signals from the conductive contacts 636 to transistors 640 and any other components integrated into the die 600.

Multiple integrated circuit devices 600 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

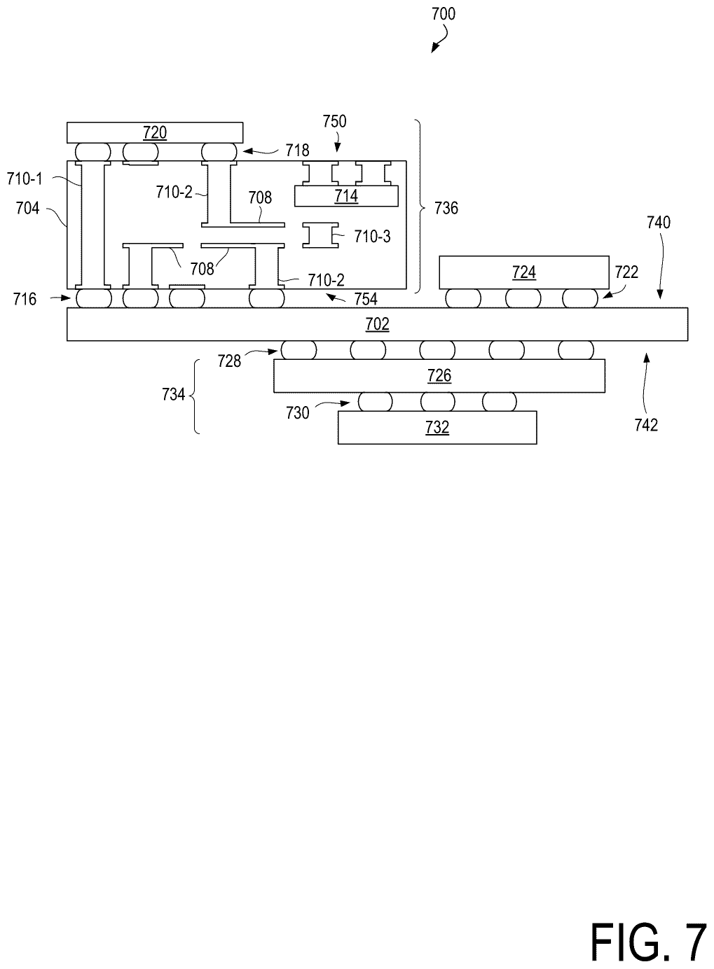

FIG. 7 is a cross-sectional side view of an integrated circuit device assembly 700 that may include any of the embodiments disclosed herein. The integrated circuit device assembly 700 includes a number of components disposed on a circuit board 702 (which may be a motherboard, system board, mainboard, etc.). The integrated circuit device assembly 700 includes components disposed on a first face 740 of the circuit board 702 and an opposing second face 742 of the circuit board 702; generally, components may be disposed on one or both faces 740 and 742.

In some embodiments, the circuit board 702 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 702. In other embodiments, the circuit board 702 may be a non-PCB substrate. The integrated circuit device assembly 700 illustrated in FIG. 7 includes a package-on-interposer structure 736 coupled to the first face 740 of the circuit board 702 by coupling components 716. The coupling components 716 may electrically and mechanically couple the package-on-interposer structure 736 to the circuit board 702, and may include solder balls (as shown in FIG. 7), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 736 may include an integrated circuit component 720 coupled to an interposer 704 by coupling components 718. The coupling components 718 may take any suitable form for the application, such as the forms discussed above with reference to the coupling components 716. Although a single integrated circuit component 720 is shown in FIG. 7, multiple integrated circuit components may be coupled to the interposer 704; indeed, additional interposers may be coupled to the interposer 704. The interposer 704 may provide an intervening substrate used to bridge the circuit board 702 and the integrated circuit component 720.

The integrated circuit component 720 may be a packaged or unpacked integrated circuit product that includes one or more integrated circuit dies (e.g., the die 502 of FIG. 5, the integrated circuit device 600 of FIG. 6) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 720, a single monolithic integrated circuit die comprises solder bumps attached to contacts on the die. The solder bumps allow the die to be directly attached to the interposer 704. The integrated circuit component 720 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 720 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 720 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 720 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 704 may spread connections to a wider pitch or reroute a connection to a different connection. For example, the interposer 704 may couple the integrated circuit component 720 to a set of ball grid array (BGA) conductive contacts of the coupling components 716 for coupling to the circuit board 702. In the embodiment illustrated in FIG. 7, the integrated circuit component 720 and the circuit board 702 are attached to opposing sides of the interposer 704; in other embodiments, the integrated circuit component 720 and the circuit board 702 may be attached to a same side of the interposer 704. In some embodiments, three or more components may be interconnected by way of the interposer 704.

In some embodiments, the interposer 704 may be formed as a PCB, including multiple metal layers separated from one another by layers of dielectric material and interconnected by electrically conductive vias. In some embodiments, the interposer 704 may be formed of an epoxy resin, a fiberglass-reinforced epoxy resin, an epoxy resin with inorganic fillers, a ceramic material, or a polymer material such as polyimide. In some embodiments, the interposer 704 may be formed of alternate rigid or flexible materials that may include the same materials described above for use in a semiconductor substrate, such as silicon, germanium, and other group III-V and group IV materials. The interposer 704 may include metal interconnects 708 and vias 710, including but not limited to through hole vias 710-1 (that extend from a first face 750 of the interposer 704 to a second face 754 of the interposer 704), blind vias 710-2 (that extend from the first or second faces 750 or 754 of the interposer 704 to an internal metal layer), and buried vias 710-3 (that connect internal metal layers).

In some embodiments, the interposer 704 can comprise a silicon interposer. Through silicon vias (TSV) extending through the silicon interposer can connect connections on a first face of a silicon interposer to an opposing second face of the silicon interposer. In some embodiments, an interposer 704 comprising a silicon interposer can further comprise one or more routing layers to route connections on a first face of the interposer 704 to an opposing second face of the interposer 704.

The interposer 704 may further include embedded devices 714, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 704. The package-on-interposer structure 736 may take the form of any of the package-on-interposer structures known in the art. In embodiments where the interposer is a non-printed circuit board

The integrated circuit device assembly 700 may include an integrated circuit component 724 coupled to the first face 740 of the circuit board 702 by coupling components 722. The coupling components 722 may take the form of any of the embodiments discussed above with reference to the coupling components 716, and the integrated circuit component 724 may take the form of any of the embodiments discussed above with reference to the integrated circuit component 720.

The integrated circuit device assembly 700 illustrated in FIG. 7 includes a package-on-package structure 734 coupled to the second face 742 of the circuit board 702 by coupling components 728. The package-on-package structure 734 may include an integrated circuit component 726 and an integrated circuit component 732 coupled together by coupling components 730 such that the integrated circuit component 726 is disposed between the circuit board 702 and the integrated circuit component 732. The coupling components 728 and 730 may take the form of any of the embodiments of the coupling components 716 discussed above, and the integrated circuit components 726 and 732 may take the form of any of the embodiments of the integrated circuit component 720 discussed above. The package-on-package structure 734 may be configured in accordance with any of the package-on-package structures known in the art.

FIG. 8 is a block diagram of an example electrical device 800 that may include one or more of the embodiments disclosed herein. For example, any suitable ones of the components of the electrical device 800 may include one or more of assemblies 100, integrated circuit devices 600, or integrated circuit dies 502 disclosed herein. A number of components are illustrated in FIG. 8 as included in the electrical device 800, but any one or more of these components may be omitted or duplicated, as suitable for the application. In some embodiments, some or all of the components included in the electrical device 800 may be attached to one or more motherboards mainboards, or system boards. In some embodiments, one or more of these components are fabricated onto a single system-on-a-chip (SoC) die.

Additionally, in various embodiments, the electrical device 800 may not include one or more of the components illustrated in FIG. 8, but the electrical device 800 may include interface circuitry for coupling to the one or more components. For example, the electrical device 800 may not include a display device 806, but may include display device interface circuitry (e.g., a connector and driver circuitry) to which a display device 806 may be coupled. In another set of examples, the electrical device 800 may not include an audio input device 824 or an audio output device 808, but may include audio input or output device interface circuitry (e.g., connectors and supporting circuitry) to which an audio input device 824 or audio output device 808 may be coupled.

The electrical device 800 may include one or more processor units 802 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 802 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 800 may include a memory 804, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 804 may include memory that is located on the same integrated circuit die as the processor unit 802. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 800 can comprise one or more processor units 802 that are heterogeneous or asymmetric to another processor unit 802 in the electrical device 800. There can be a variety of differences between the processing units 802 in a system in terms of a spectrum of metrics of merit including architectural, microarchitectural, thermal, power consumption characteristics, and the like. These differences can effectively manifest themselves as asymmetry and heterogeneity among the processor units 802 in the electrical device 800.

In some embodiments, the electrical device 800 may include a communication component 812 (e.g., one or more communication components). For example, the communication component 812 can manage wireless communications for the transfer of data to and from the electrical device 800. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 812 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 812 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 812 may operate in accordance with other wireless protocols in other embodiments. The electrical device 800 may include an antenna 822 to facilitate wireless communications and/or to receive other wireless communications (such as AM or FM radio transmissions).

In some embodiments, the communication component 812 may manage wired communications, such as electrical, optical, or any other suitable communication protocols (e.g., IEEE 802.3 Ethernet standards). As noted above, the communication component 812 may include multiple communication components. For instance, a first communication component 812 may be dedicated to shorter-range wireless communications such as Wi-Fi or Bluetooth, and a second communication component 812 may be dedicated to longer-range wireless communications such as global positioning system (GPS), EDGE, GPRS, CDMA, WiMAX, LTE, EV-DO, or others. In some embodiments, a first communication component 812 may be dedicated to wireless communications, and a second communication component 812 may be dedicated to wired communications.

The electrical device 800 may include battery/power circuitry 814. The battery/power circuitry 814 may include one or more energy storage devices (e.g., batteries or capacitors) and/or circuitry for coupling components of the electrical device 800 to an energy source separate from the electrical device 800 (e.g., AC line power).

The electrical device 800 may include a display device 806 (or corresponding interface circuitry, as discussed above). The display device 806 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 800 may include an audio output device 808 (or corresponding interface circuitry, as discussed above). The audio output device 808 may include any embedded or wired or wirelessly connected external device that generates an audible indicator, such speakers, headsets, or earbuds.

The electrical device 800 may include an audio input device 824 (or corresponding interface circuitry, as discussed above). The audio input device 824 may include any embedded or wired or wirelessly connected device that generates a signal representative of a sound, such as microphones, microphone arrays, or digital instruments (e.g., instruments having a musical instrument digital interface (MIDI) output). The electrical device 800 may include a Global Navigation Satellite System (GNSS) device 818 (or corresponding interface circuitry, as discussed above), such as a Global Positioning System (GPS) device. The GNSS device 818 may be in communication with a satellite-based system and may determine a geolocation of the electrical device 800 based on information received from one or more GNSS satellites, as known in the art.

The electrical device 800 may include another output device 810 (or corresponding interface circuitry, as discussed above). Examples of the other output device 810 may include an audio codec, a video codec, a printer, a wired or wireless transmitter for providing information to other devices, or an additional storage device.

The electrical device 800 may include another input device 820 (or corresponding interface circuitry, as discussed above). Examples of the other input device 820 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 800 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra-mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 800 may be any other electronic device that processes data. In some embodiments, the electrical device 800 may comprise multiple discrete physical components. Given the range of devices that the electrical device 800 can be manifested as in various embodiments, in some embodiments, the electrical device 800 can be referred to as a computing device or a computing system.

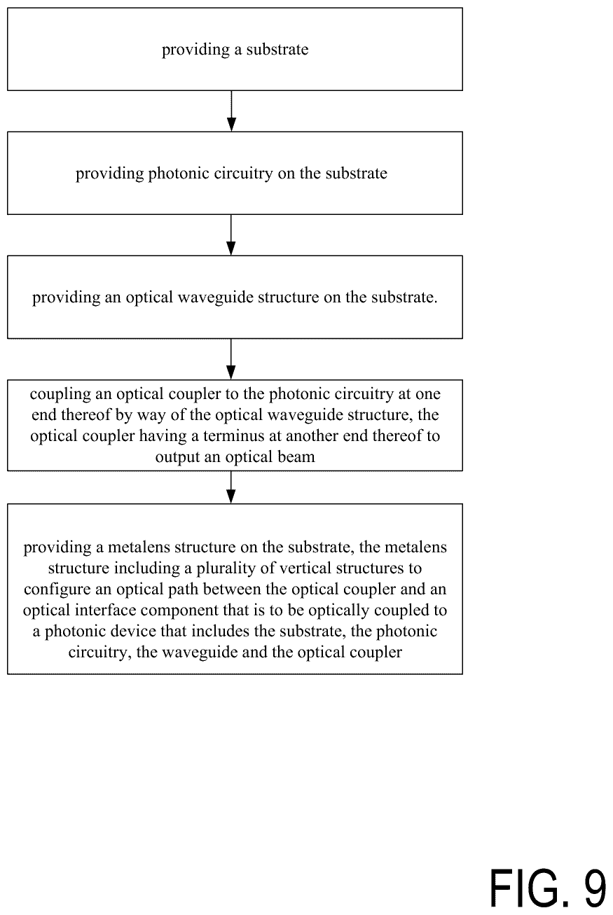

FIG. 9 shows a flow chart of a process 900 according to one embodiment. Process 900 includes, at operation 902, providing a substrate; at operation 904, providing photonic circuitry on the substrate; and at operation 906, providing an optical waveguide structure on the substrate. Process 900 includes, at operation 908, coupling an optical coupler to the photonic circuitry at one end thereof by way of the optical waveguide structure, the optical coupler having a terminus at another end thereof to output an optical beam, and at operation 910, providing a metalens structure on the substrate, the metalens structure including a plurality of vertical structures to configure an optical path between the optical coupler and an optical interface component that is to be optically coupled to the photonic device.

### EXAMPLES

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes a photonic device including: a substrate; photonic circuitry on the substrate; an optical waveguide structure on the substrate; an optical coupler coupled to the photonic circuitry at one end thereof by way of the optical waveguide structure, and having a terminus at another end thereof to output an optical beam; and a metalens structure on the substrate, the metalens structure including a plurality of vertical structures to configure an optical path between the optical coupler and an optical interface component that is to be optically coupled to the photonic device.

Example 2 includes the subject matter of Example 1, wherein the metalens structure is to configure the optical path by at least one of expanding the optical beam from the optical coupler or substantially collimating the optical beam from the optical coupler.

Example 3 includes the subject matter of any one of Examples 1-2, wherein the vertical structures define a heterogenous pattern across an exposed surface of the metalens structure.

Example 4 includes the subject matter of Example 3, wherein a footprint of the vertical structures at a central region of the exposed surface of the metalens structure is different from a footprint of the vertical structures at peripheral regions of the exposed surface of the metalens structure.

Example 5 includes the subject matter of any one of Examples 1-4, wherein the vertical structures include nanostructures.

Example 6 includes the subject matter of any one of Examples 1-4, wherein the vertical structures include pillars.

Example 7 includes the subject matter of Example 6, wherein the pillars have cross sections that are at least one of circular, square, rectangular, or triangular.

Example 8 includes the subject matter of any one of Examples 1-7, wherein the exposed surface of the metalens structure is substantially flat.

Example 9 includes the subject matter of Example 8, further defining a cavity therein, the metalens structure in the cavity.

Example 10 includes the subject matter of Example 9, wherein the optical coupler is an edge coupler, and wherein the exposed surface of the metalens structure defines an angle different from 0 degree or 180 degree with respect to a top surface of the substrate.

Example 11 includes the subject matter of Example 10, further including a filler material in the cavity, the filler material having a ramping surface defining the angle with respect to the top surface of the substrate, the metalens structure disposed in the cavity on the ramping surface.

Example 12 includes the subject matter of Example 11, wherein the filler material includes at least one of oxygen or a polymer.

Example 13 includes the subject matter of any one of Examples 1-12, wherein the optical path includes a first optical path portion between the optical coupler and the metalens structure, and a second optical path portion between the metalens structure and the optical interface component to be optically coupled to the photonic device.

Example 14 includes the subject matter of Example 8, wherein the optical coupler is a vertical coupler.

Example 15 includes the subject matter of Example 14, wherein the exposed surface of the metalens structure is substantially parallel with a top surface of the substrate.

Example 16 includes the subject matter of any one of Examples 14-15, further including a transparent block assembly comprising an optically transparent block abutting the vertical coupler and the cavity at a bottom surface thereof, and a mirror structure on a top surface of the optically transparent block opposite the vertical coupler and the cavity.

Example 17 includes the subject matter of Example 16, wherein the mirror structure includes a layer of metal.

Example 18 includes the subject matter of any one of Examples 16-17, wherein the optically transparent block includes at least one of glass and silicon.

Example 19 includes the subject matter of any one of Examples 16-18, wherein the optical path includes a first optical path portion through the optically transparent block and between the optical coupler and the mirror structure, a second optical path portion through the optically transparent block between the mirror structure and the metalens structure, and a third optical path portion through the optically transparent block between the metalens structure and the top surface of the optically transparent block.

Example 20 includes the subject matter of Example 14, wherein the substrate, photonic circuitry, optical waveguide structure, and optical coupler are part of a photonic integrated circuit (PIC) of the photonic device, the photonic device further including a metalens assembly, the metalens assembly comprising the metalens structure and an optically transparent block abutting a top surface of the PIC, the metalens structure on a surface of the optically transparent block that is substantially parallel to a top surface of the substrate.

Example 21 includes the subject matter of Example 20, wherein the optically transparent block includes at least one of glass or silicon.

Example 22 includes the subject matter of Example 20, wherein the metalens structure is a first metalens structure, the metalens assembly further including a second metalens structure facing the first metalens structure.

Example 23 includes the subject matter of Example 22, wherein the optically transparent block defines a cavity at a bottom region thereof, the cavity facing the PIC, the first metalens structure disposed on a surface of the cavity facing the vertical coupler, the second metalens structure disposed on a top surface of the optically transparent block.

Example 24 includes the subject matter of Example 23, wherein the optical path includes a first optical path portion between the optical coupler and the first metalens structure, a second optical path portion through the optically transparent block between the first metalens structure and the second metalens structure, and a third optical path portion from the second metalens structure in a direction toward the optical interface component to be optically coupled to the PIC.

Example 25 includes a semiconductor package, comprising: a package substrate; a photonic device on the package substrate and electrically and optically coupled thereto, the photonic device including: a substrate; photonic circuitry on the substrate; an optical waveguide structure on the substrate; an optical coupler coupled to the photonic circuitry at one end thereof by way of the optical waveguide structure, and having a terminus at another end thereof to output an optical beam; and a metalens structure on the substrate, the metalens structure including a plurality of vertical structures to configure an optical path between the optical coupler and an optical interface component that is to be optically coupled to the photonic device.

Example 26 includes the subject matter of Example 25, wherein the metalens structure is to configure the optical path by at least one of expanding the optical beam from the optical coupler or substantially collimating the optical beam from the optical coupler.

Example 27 includes the subject matter of any one of Examples 25-26, wherein the vertical structures define a heterogenous pattern across an exposed surface of the metalens structure.

Example 28 includes the subject matter of Example 27, wherein a footprint of the vertical structures at a central region of the exposed surface of the metalens structure is different from a footprint of the vertical structures at peripheral regions of the exposed surface of the metalens structure.

Example 29 includes the subject matter of any one of Examples 25-28, wherein the vertical structures include nanostructures.

Example 30 includes the subject matter of any one of Examples 25-28, wherein the vertical structures include pillars.

Example 31 includes the subject matter of Example 30, wherein the pillars have cross sections that are at least one of circular, square, rectangular, or triangular.

Example 32 includes the subject matter of any one of Examples 25-31, wherein the exposed surface of the metalens structure is substantially flat.

Example 33 includes the subject matter of Example 32, further defining a cavity therein, the metalens structure in the cavity.

Example 34 includes the subject matter of Example 33, wherein the optical coupler is an edge coupler, and wherein the exposed surface of the metalens structure defines an angle different from 0 degree or 180 degree with respect to a top surface of the substrate.

Example 35 includes the subject matter of Example 34, further including a filler material in the cavity, the filler material having a ramping surface defining the angle with respect to the top surface of the substrate, the metalens structure disposed in the cavity on the ramping surface.

Example 36 includes the subject matter of Example 35, wherein the filler material includes at least one of oxygen or a polymer.

Example 37 includes the subject matter of any one of Examples 25-36, wherein the optical path includes a first optical path portion between the optical coupler and the metalens structure, and a second optical path portion between the metalens structure and the optical interface component to be optically coupled to the photonic device.

Example 38 includes the subject matter of Example 32, wherein the optical coupler is a vertical coupler.

Example 39 includes the subject matter of Example 38, wherein the exposed surface of the metalens structure is substantially parallel with a top surface of the substrate.

Example 40 includes the subject matter of any one of Examples 38-39, further including a transparent block assembly comprising an optically transparent block abutting the vertical coupler and the cavity at a bottom surface thereof, and a mirror structure on a top surface of the optically transparent block opposite the vertical coupler and the cavity.

Example 41 includes the subject matter of Example 40, wherein the mirror structure includes a layer of metal.

Example 42 includes the subject matter of any one of Examples 40-41, wherein the optically transparent block includes at least one of glass and silicon.

Example 43 includes the subject matter of any one of Examples 40-42, wherein the optical path includes a first optical path portion through the optically transparent block and between the optical coupler and the mirror structure, a second optical path portion through the optically transparent block between the mirror structure and the metalens structure, and a third optical path portion through the optically transparent block between the metalens structure and the top surface of the optically transparent block.

Example 44 includes the subject matter of Example 38, wherein the substrate, photonic circuitry, optical waveguide structure, and optical coupler are part of a photonic integrated circuit (PIC) of the photonic device, the photonic device further including a metalens assembly, the metalens assembly comprising the metalens structure and an optically transparent block abutting a top surface of the PIC, the metalens structure on a surface of the optically transparent block that is substantially parallel to a top surface of the substrate.

Example 45 includes the subject matter of Example 44, wherein the optically transparent block includes at least one of glass or silicon.

Example 46 includes the subject matter of Example 44, wherein the metalens structure is a first metalens structure, the metalens assembly further including a second metalens structure facing the first metalens structure.

Example 47 includes the subject matter of Example 46, wherein the optically transparent block defines a cavity at a bottom region thereof, the cavity facing the PIC, the first metalens structure disposed on a surface of the cavity facing the vertical coupler, the second metalens structure disposed on a top surface of the optically transparent block.

Example 48 includes the subject matter of Example 47, wherein the optical path includes a first optical path portion between the optical coupler and the first metalens structure, a second optical path portion through the optically transparent block between the first metalens structure and the second metalens structure, and a third optical path portion from the second metalens structure in a direction toward the optical interface component to be optically coupled to the PIC.

Example 49 includes an integrated circuit (IC) device assembly including: a printed circuit board; a package substrate on the printed circuit board and electrically coupled thereto; and a photonic device on the package substrate and electrically and optically coupled thereto, the photonic device including: a substrate; photonic circuitry on the substrate; an optical waveguide structure on the substrate; an optical coupler coupled to the photonic circuitry at one end thereof by way of the optical waveguide structure, and having a terminus at another end thereof to output an optical beam; and a metalens structure on the substrate, the metalens structure including a plurality of vertical structures to configure an optical path between the optical coupler and an optical interface component that is to be optically coupled to the photonic device.

Example 50 includes the subject matter of Example 49, wherein the metalens structure is to configure the optical path by at least one of expanding the optical beam from the optical coupler or substantially collimating the optical beam from the optical coupler.

Example 51 includes the subject matter of any one of Examples 49-50, wherein the vertical structures define a heterogenous pattern across an exposed surface of the metalens structure.

Example 52 includes the subject matter of Example 51, wherein a footprint of the vertical structures at a central region of the exposed surface of the metalens structure is different from a footprint of the vertical structures at peripheral regions of the exposed surface of the metalens structure.

Example 53 includes the subject matter of any one of Examples 49-52, wherein the vertical structures include nanostructures.

Example 54 includes the subject matter of any one of Examples 49-52, wherein the vertical structures include pillars.

Example 55 includes the subject matter of Example 54, wherein the pillars have cross sections that are at least one of circular, square, rectangular, or triangular.

Example 56 includes the subject matter of any one of Examples 49-55, wherein the exposed surface of the metalens structure is substantially flat.

Example 57 includes the subject matter of Example 56, further defining a cavity therein, the metalens structure in the cavity.

Example 58 includes the subject matter of Example 57, wherein the optical coupler is an edge coupler, and wherein the exposed surface of the metalens structure defines an angle different from 0 degree or 180 degree with respect to a top surface of the substrate.

Example 59 includes the subject matter of Example 58, further including a filler material in the cavity, the filler material having a ramping surface defining the angle with respect to the top surface of the substrate, the metalens structure disposed in the cavity on the ramping surface.

Example 60 includes the subject matter of Example 59, wherein the filler material includes at least one of oxygen or a polymer.

Example 61 includes the subject matter of any one of Examples 49-60, wherein the optical path includes a first optical path portion between the optical coupler and the metalens structure, and a second optical path portion between the metalens structure and the optical interface component to be optically coupled to the photonic device.

Example 62 includes the subject matter of Example 56, wherein the optical coupler is a vertical coupler.

Example 63 includes the subject matter of Example 62, wherein the exposed surface of the metalens structure is substantially parallel with a top surface of the substrate.

Example 64 includes the subject matter of any one of Examples 62-63, further including a transparent block assembly comprising an optically transparent block abutting the vertical coupler and the cavity at a bottom surface thereof, and a mirror structure on a top surface of the optically transparent block opposite the vertical coupler and the cavity.

Example 65 includes the subject matter of Example 64, wherein the mirror structure includes a layer of metal.

Example 66 includes the subject matter of any one of Examples 64-65, wherein the optically transparent block includes at least one of glass and silicon.

Example 67 includes the subject matter of any one of Examples 64-66, wherein the optical path includes a first optical path portion through the optically transparent block and between the optical coupler and the mirror structure, a second optical path portion through the optically transparent block between the mirror structure and the metalens structure, and a third optical path portion through the optically transparent block between the metalens structure and the top surface of the optically transparent block.

Example 68 includes the subject matter of Example 62, wherein the substrate, photonic circuitry, optical waveguide structure, and optical coupler are part of a photonic integrated circuit (PIC) of the photonic device, the photonic device further including a metalens assembly, the metalens assembly comprising the metalens structure and an optically transparent block abutting a top surface of the PIC, the metalens structure on a surface of the optically transparent block that is substantially parallel to a top surface of the substrate.

Example 69 includes the subject matter of Example 68, wherein the optically transparent block includes at least one of glass or silicon.

Example 70 includes the subject matter of Example 68, wherein the metalens structure is a first metalens structure, the metalens assembly further including a second metalens structure facing the first metalens structure.

Example 71 includes the subject matter of Example 70, wherein the optically transparent block defines a cavity at a bottom region thereof, the cavity facing the PIC, the first metalens structure disposed on a surface of the cavity facing the vertical coupler, the second metalens structure disposed on a top surface of the optically transparent block.

Example 72 includes the subject matter of Example 71, wherein the optical path includes a first optical path portion between the optical coupler and the first metalens structure, a second optical path portion through the optically transparent block between the first metalens structure and the second metalens structure, and a third optical path portion from the second metalens structure in a direction toward the optical interface component to be optically coupled to the PIC.

Example 73 includes a method of fabricating a photonic device including: providing a substrate; providing photonic circuitry on the substrate; providing an optical waveguide structure on the substrate; coupling an optical coupler to the photonic circuitry at one end thereof by way of the optical waveguide structure, the optical coupler having a terminus at another end thereof to output an optical beam; and providing a metalens structure on the substrate, the metalens structure including a plurality of vertical structures to configure an optical path between the optical coupler and an optical interface component that is to be optically coupled to the photonic device.

Example 74 includes the subject matter of Example 73, wherein the metalens structure is to configure the optical path by at least one of expanding the optical beam from the optical coupler or substantially collimating the optical beam from the optical coupler.

Example 75 includes the subject matter of any one of Examples 73-74, wherein providing the metalens structure includes etching to provides the vertical structures, the vertical structures defining a heterogenous pattern across an exposed surface of the metalens structure.

Example 76 includes the subject matter of Example 75, wherein a footprint of the vertical structures at a central region of the exposed surface of the metalens structure is different from a footprint of the vertical structures at peripheral regions of the exposed surface of the metalens structure.

Example 77 includes the subject matter of any one of Examples 73-76, wherein the vertical structures include nanostructures.

Example 78 includes the subject matter of any one of Examples 73-76, wherein the vertical structures include pillars.

Example 79 includes the subject matter of Example 78, wherein the pillars have cross sections that are at least one of circular, square, rectangular, or triangular.

Example 80 includes the subject matter of any one of Examples 73-79, wherein the exposed surface of the metalens structure is substantially flat.

Example 81 includes the subject matter of Example 80, further including providing a cavity within the photonic device, and providing the metalens structure in the cavity.

Example 82 includes the subject matter of Example 81, wherein the optical coupler is an edge coupler, and wherein the exposed surface of the metalens structure defines an angle different from 0 degree or 180 degree with respect to a top surface of the substrate.

Example 83 includes the subject matter of Example 82, further including: providing a filler material in the cavity; etching the filler material to create a ramping surface of the filler material, the ramping surface defining the angle with respect to the top surface of the substrate; and providing the metalens structure in the cavity on the ramping surface.

Example 84 includes the subject matter of Example 83, wherein the filler material includes at least one of oxygen or a polymer.

Example 85 includes the subject matter of any one of Examples 73-84, wherein the optical path includes a first optical path portion between the optical coupler and the metalens structure, and a second optical path portion between the metalens structure and the optical interface component to be optically coupled to the photonic device.

Example 86 includes the subject matter of Example 80, wherein the optical coupler is a vertical coupler.

Example 87 includes the subject matter of Example 86, wherein the exposed surface of the metalens structure is substantially parallel with a top surface of the substrate.

Example 88 includes the subject matter of any one of Examples 86-87, further including providing a transparent block assembly comprising an optically transparent block abutting the vertical coupler and the cavity at a bottom surface thereof, and providing a mirror structure on a top surface of the optically transparent block opposite the vertical coupler and the cavity.

Example 89 includes the subject matter of Example 88, wherein the mirror structure includes a layer of metal.

Example 90 includes the subject matter of any one of Examples 88-89, wherein the optically transparent block includes at least one of glass and silicon.

Example 91 includes the subject matter of any one of Examples 88-89, wherein the optical path includes a first optical path portion through the optically transparent block and between the optical coupler and the mirror structure, a second optical path portion through the optically transparent block between the mirror structure and the metalens structure, and a third optical path portion through the optically transparent block between the metalens structure and the top surface of the optically transparent block.

Example 92 includes the subject matter of Example 88, wherein the substrate, photonic circuitry, optical waveguide structure, and optical coupler are part of a photonic integrated circuit (PIC) of the photonic device, the method further including providing a metalens assembly, the metalens assembly comprising the metalens structure and an optically transparent block abutting a top surface of the PIC, the metalens structure on a surface of the optically transparent block that is substantially parallel to a top surface of the substrate.

Example 93 includes the subject matter of Example 92, wherein the optically transparent block includes at least one of glass or silicon.

Example 94 includes the subject matter of Example 92, wherein the metalens structure is a first metalens structure, the method further including providing a second metalens structure of the metalens assembly facing the first metalens structure.

Example 95 includes the subject matter of Example 94, further including providing a cavity in the optically transparent block at a bottom region thereof, the cavity facing the PIC, the first metalens structure disposed on a surface of the cavity facing the vertical coupler, the second metalens structure disposed on a top surface of the optically transparent block.

Example 96 includes the subject matter of Example 95, wherein the optical path includes a first optical path portion between the optical coupler and the first metalens structure, a second optical path portion through the optically transparent block between the first metalens structure and the second metalens structure, and a third optical path portion from the second metalens structure in a direction toward the optical interface component to be optically coupled to the PIC.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

In embodiments, the phrase “A is located on B” means that at least a part of A is in direct physical contact or indirect physical contact (having one or more other features between A and B) with at least a part of B.

In the instant description, “A is adjacent to B” means that at least part of A is in direct physical contact with at least part of B, or that at least part of A is near at least part of B.

In the instant description, “B is between A and C” means that at least part of B is in or along a space separating A and C and that the at least part of B is in direct or indirect physical contact with A and C.

In the instant description, “A is attached to B” means that at least part of A is mechanically attached to at least part of B, either directly or indirectly (having one or more other features between A and B).

The use of reference numerals separated by a “/”, such as “102/104” for example, is intended to refer to 102 or 104 as appropriate. Otherwise, the forward slash (“/”) as used herein means “and/or.”

The use of the techniques and structures provided herein can be detected using tools such as: electron microscopy including scanning/transmission electron microscopy (SEM/TEM), scanning transmission electron microscopy (STEM), nano-beam electron diffraction (NBD or NBED), and reflection electron microscopy (REM); composition mapping; x-ray crystallography or diffraction (XRD); energy-dispersive x-ray spectroscopy (EDX); secondary ion mass spectrometry (SIMS); time-of-flight SIMS (ToF-SIMS); atom probe imaging or tomography; local electrode atom probe (LEAP) techniques; 3D tomography; or high resolution physical or chemical analysis, to name a few suitable example analytical tools. In particular, such tools can indicate an integrated circuit including at least one MCP including an interposer bonded to a MCP subassembly through direct dielectric-to-dielectric bonding as described herein.

In some embodiments, the techniques, processes and/or methods described herein can be detected based on the structures formed therefrom. In addition, in some embodiments, the techniques and structures described herein can be detected based on the benefits derived therefrom. Numerous configurations and variations will be apparent in light of this disclosure.

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” “according to some embodiments,” “in accordance with embodiments,” or “in embodiments,” which may each refer to one or more of the same or different embodiments. Furthermore, the terms “comprising,” “including,” “having,” and the like, as used with respect to embodiments of the present disclosure, are synonymous.

“Coupled” as used herein means that two or more elements are in direct physical contact, or that that two or more elements indirectly physically contact each other, but yet still cooperate or interact with each other (i.e. one or more other elements are coupled or connected between the elements that are said to be coupled with each other). The term “directly coupled” means that two or more elements are in direct contact.

As used herein, the term “module” refers to being part of, or including an ASIC, an electronic circuit, a system on a chip, a processor (shared, dedicated, or group), a solid state device, a memory (shared, dedicated, or group) that execute one or more software or firmware programs, a combinational logic circuit, and/or other suitable components that provide the described functionality.

As used herein, “electrically conductive” in some examples may refer to a property of a material having an electrical conductivity greater than or equal to 107 Siemens per meter (S/m) at 20 degrees Celsius. Examples of such materials include Cu, Ag, Al, Au, W, Zn and Ni.

As used herein, an “integrated circuit structure” or “may include one or more microelectronic dies.

In the corresponding drawings of the embodiments, signals, currents, electrical biases, or magnetic or electrical polarities may be represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, polarity, current, voltage, etc., as dictated by design needs or preferences, may actually comprise one or more signals that may travel in either direction or may be implemented with any suitable type of signal scheme.

Throughout the specification, and in the claims, the term “connected” means a direct connection, such as electrical, mechanical, or magnetic connection between the elements that are connected, without any intermediary devices. The term “coupled” means a direct or indirect connection, such as a direct electrical, mechanical, or magnetic connection between the elements that are connected or an indirect connection, through one or more passive or active intermediary devices. The term “signal” may refer to at least one current signal, voltage signal, magnetic signal, or data/clock signal. The meaning of “a,” “an,” and “the” include plural references. The meaning of “in” includes “in” and “on.”

The terms “substantially,” “close,” “approximately,” “near,” and “about,” generally refer to being within +/−10% of a target value (unless specifically specified). Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For purposes of the embodiments, the transistors in various circuits and logic blocks described here are metal oxide semiconductor (MOS) transistors or their derivatives, where the MOS transistors include drain, source, gate, and bulk terminals. The transistors and/or the MOS transistor derivatives also include Tri-Gate and FinFET transistors, Gate All Around Cylindrical Transistors, Tunneling FET (TFET), Square Wire, or Rectangular Ribbon Transistors, ferroelectric FET (FeFETs), or other devices implementing transistor functionality like carbon nanotubes or spintronic devices. MOSFET symmetrical source and drain terminals i.e., are identical terminals and are interchangeably used here. A TFET device, on the other hand, has asymmetric Source and Drain terminals. Those skilled in the art will appreciate that other transistors, for example, Bi-polar junction transistors—BJT PNP/NPN, BiCMOS, CMOS, eFET, etc., may be used without departing from the scope of the disclosure. The term “MN” indicates an n-type transistor (e.g., nMOS, NPN BJT, etc.) and the term “MP” indicates a p-type transistor (e.g., pMOS, PNP BJT, etc.).

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

1. A photonic device including:
a substrate;
photonic circuitry on the substrate;
an optical waveguide structure on the substrate;
an optical coupler coupled to the photonic circuitry at one end thereof by way of the optical waveguide structure, and having a terminus at another end thereof to output an optical beam; and
a metalens structure on the substrate, the metalens structure including a plurality of vertical nanostructures to configure an optical path between the optical coupler and an optical interface component that is to be optically coupled to the photonic device.

2. The photonic device of claim 1, wherein the metalens structure is to configure the optical path by at least one of expanding the optical beam from the optical coupler or substantially collimating the optical beam from the optical coupler.

3. The photonic device of claim 1, wherein the vertical structures define a heterogenous pattern across an exposed surface of the metalens structure.

4. The photonic device of claim 3, wherein a footprint of the vertical structures at a central region of the exposed surface of the metalens structure is different from a footprint of the vertical structures at peripheral regions of the exposed surface of the metalens structure.

5. The photonic device of claim 1, wherein the exposed surface of the metalens structure is substantially flat.

6. The photonic device of claim 5, further defining a cavity therein, the metalens structure in the cavity.

7. The photonic device of claim 6, wherein the optical coupler is an edge coupler, and wherein the exposed surface of the metalens structure defines an angle different from 0 degree or 180 degree with respect to a top surface of the substrate.

8. The photonic device of claim 7, further including a filler material in the cavity, the filler material having a ramping surface defining the angle with respect to the top surface of the substrate, the metalens structure disposed in the cavity on the ramping surface.

9. The photonic device of claim 1, wherein the optical path includes a first optical path portion between the optical coupler and the metalens structure, and a second optical path portion between the metalens structure and the optical interface component to be optically coupled to the photonic device.

10. The photonic device of claim 5, wherein the optical coupler is a vertical coupler.

11. The photonic device of claim 10, wherein the exposed surface of the metalens structure is substantially parallel with a top surface of the substrate.

12. The photonic device of claim 11, further including a transparent block assembly comprising an optically transparent block abutting the vertical coupler and the cavity at a bottom surface thereof, and a mirror structure on a top surface of the optically transparent block opposite the vertical coupler and the cavity.

13. The photonic device of claim 12, wherein the optical path includes a first optical path portion through the optically transparent block and between the optical coupler and the mirror structure, a second optical path portion through the optically transparent block between the mirror structure and the metalens structure, and a third optical path portion through the optically transparent block between the metalens structure and the top surface of the optically transparent block.

14. The photonic device of claim 10, wherein the substrate, photonic circuitry, optical waveguide structure, and optical coupler are part of a photonic integrated circuit (PIC) of the photonic device, the photonic device further including a metalens assembly, the metalens assembly comprising the metalens structure and an optically transparent block abutting a top surface of the PIC, the metalens structure on a surface of the optically transparent block that is substantially parallel to a top surface of the substrate.

15. The photonic device of claim 14, wherein the metalens structure is a first metalens structure, the metalens assembly further including a second metalens structure facing the first metalens structure.

16. The photonic device of claim 15, wherein the optically transparent block defines a cavity at a bottom region thereof, the cavity facing the PIC, the first metalens structure disposed on a surface of the cavity facing the vertical coupler, the second metalens structure disposed on a top surface of the optically transparent block.

17. The photonic device of claim 16, wherein the optical path includes a first optical path portion between the optical coupler and the first metalens structure, a second optical path portion through the optically transparent block between the first metalens structure and the second metalens structure, and a third optical path portion from the second metalens structure in a direction toward the optical interface component to be optically coupled to the PIC.

18. A semiconductor package, comprising:
a package substrate;
a photonic device on the package substrate and electrically and optically coupled thereto, the photonic device including:
a substrate;
photonic circuitry on the substrate;
an optical waveguide structure on the substrate;
an optical coupler coupled to the photonic circuitry at one end thereof by way of the optical waveguide structure, and having a terminus at another end thereof to output an optical beam; and
a metalens structure on the substrate, the metalens structure including a plurality of vertical structures to configure an optical path between the optical coupler and an optical interface component that is to be optically coupled to the photonic device.

19. The semiconductor package of claim 18, wherein the metalens structure is to configure the optical path by at least one of expanding the optical beam from the optical coupler or substantially collimating the optical beam from the optical coupler.

20. The semiconductor package of claim 18, wherein the vertical structures define a heterogenous pattern across an exposed surface of the metalens structure.

21. An integrated circuit (IC) device assembly including:
a printed circuit board;
a package substrate on the printed circuit board and electrically coupled thereto; and
a photonic device on the package substrate and electrically and optically coupled thereto, the photonic device including:
a substrate;
photonic circuitry on the substrate;
an optical waveguide structure on the substrate;
an optical coupler coupled to the photonic circuitry at one end thereof by way of the optical waveguide structure, and having a terminus at another end thereof to output an optical beam; and
a metalens structure on the substrate, the metalens structure including a plurality of vertical structures to configure an optical path between the optical coupler and an optical interface component that is to be optically coupled to the photonic device.

22. The IC device assembly of claim 21, wherein the metalens structure is to configure the optical path by at least one of expanding the optical beam from the optical coupler or substantially collimating the optical beam from the optical coupler.

23. The IC device assembly of any one of claim 21, wherein the vertical structures define a heterogenous pattern across an exposed surface of the metalens structure.

24. A method of fabricating a photonic device including:
providing a substrate;
providing photonic circuitry on the substrate;
providing an optical waveguide structure on the substrate;
coupling an optical coupler to the photonic circuitry at one end thereof by way of the optical waveguide structure, the optical coupler having a terminus at another end thereof to output an optical beam; and
providing a metalens structure on the substrate, the metalens structure including a plurality of vertical structures to configure an optical path between the optical coupler and an optical interface component that is to be optically coupled to the photonic device.

25. The method of claim 24, wherein the metalens structure is to configure the optical path by at least one of expanding the optical beam from the optical coupler or substantially collimating the optical beam from the optical coupler.
